(19) United States
(12) Patent Application Publication
(10) Pub. No.: US 2006/0234017 A1
(43) Pub. Date: Oct. 19, 2006

(54) Printed sheet for flooring material and flooring material

(76) Inventors: Isao Tajima, Tokyo (JP); Toshiyuki Orikasa, Tokyo (JP); Kayoko Kooriyama, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 11/393,120

(22) Filed: Mar. 30, 2006

(30) Foreign Application Priority Data
Mar. 30, 2005 (JP) P2005-099840

(51) Int. Cl. B44C 1/17

(52) U.S. Cl. 428/195.1

(57) ABSTRACT

A printed sheet for flooring material to be disposed between a backer layer and a top sheet in a flooring material, wherein: the printed sheet for flooring material comprises at least a urethane type resin layer, a printed layer, and a first composite material layer; the printed sheet for flooring material comprises the urethane type resin layer and the first composite material layer in this order from a side of the backer layer in the printed sheet; and the first composite material layer comprises at least an EMAA resin layer and a first polyethylene resin layer in this order from a side of the top sheet in the printed sheet.

### BACKGROUND OF THE INVENTION

1. Field of the Invention

The present invention relates to a flooring material and a printed sheet for flooring material to be included in the flooring material. More particularly, the present invention relates to a printed sheet for flooring material which has improved stability by preventing delamination, and the like.

2. Related Art

As a flooring material to be used as a building material, there is known a flooring material in which a backer layer (1), a printed sheet (2) and a topsheet (an ionomer resin layer) (3) are laminated. Such a flooring material is usually fabricated by interposing the printed sheet (2) between the backer layer (1) and the top sheet (3) and by subjecting the laminate thus obtained to heat lamination. The printed sheet (2) as referred to herein is formed by sequentially laminating, from a side of the backer layer of the printed sheet (2), a primer layer, a printed layer and a layer of an ionomer resin in which metal ions are involved in crosslinkage between the molecules of an ethylene-methacrylic acid copolymer.

Such a flooring material is involved in a problem that delamination tests of each of the layers, carried out before and after weatherability test, reveal that each layer tends to be delaminated, more specifically, the interface between the backer layer (1) and the printed sheet (2) and the interface between the printed sheet (2) and the top sheet (3) frequently undergo delamination, making the stability of the flooring material poor as the case may be.

Under these circumstances, there has been developed a flooring material including such a printed sheet (2) that on a side of the top sheet of the printed layer, in place of the ionomer resin layer with metal ions involved in crosslinkage between the molecules of an ethylene-methacrylic acid copolymer, there are sequentially laminated a resin layer made of a 1:1 mixture of EMMA and LLDPE, a LLDPE layer, and a resin layer made of a 1:1 mixture of EMMA and LLDPE (for example, refer to Japanese Patent Application Laid-Open No. 2004-3191, UK Patent Application No. GB2389075A, Example 3 in Table 1, or the like)

### SUMMARY OF THE INVENTION

In the above described flooring material, however, the resin layer made of a 1:1-mixture of EMMA and LLDPE is hard, and hence tight adhesion is attained when this resin layer and the layer adjacent thereto adhere to each other in a satisfactory manner, but the interface between these layers sometimes undergoes easy delamination due to external impact or the like.

In view of the above circumstances, an object of the present invention is to provide a flooring material having improved stability and strength and to provide a printed sheet for flooring material, to be used in such a flooring material.

The above object of the present invention can be achieved by a printed sheet for flooring material to be disposed between a backer layer and a top sheet in a flooring material, wherein: the printed sheet for flooring material comprises at least a urethane type resin layer, a printed layer, and a first composite material layer; the printed sheet for flooring material comprises the urethane type resin layer and the first composite material layer in this order from a side of the backer layer in the printed sheet; and the first composite material layer comprises at least an EMAA resin layer and a first polyethylene resin layer in this order from a side of the top sheet in the printed sheet.

According to the present invention, the EMAA resin is a soft material, and the EMAA resin and the ionomer resin are similar in properties because the EMAA resin is a resin prepared by eliminating the metal crosslinkage from the ionomer resin usually used for the top sheet. Consequently, the disposition of the EMAA resin layer on the side of the top sheet of the printed sheet for flooring material makes satisfactory the adhesion between the top sheet and the printed sheet for flooring material in such a way that each of the layers hardly undergoes delamination to be caused by external impact and hence the flooring material acquires stability, and the strength of the flooring material can also be improved.

In one aspect of the present invention, the printed sheet for flooring material is wherein the first composite material layer further comprises a second polyethylene resin layer made of a material different from a material for the first polyethylene resin layer on a side of the urethane type resin layer in the first composite material layer.

According to the present invention, further disposition of a second polyethylene resin layer on a side of the urethane type resin layer of the first composite material layer can make satisfactory the adhesion between the urethane type resin layer and the second polyethylene resin layer and the adhesion between the optionally disposed printed layer and the second polyethylene layer through controlling the properties of the second polyethylene resin layer, and thus the provision of a flooring material having a high stability is made possible.

In another aspect of the present invention, the printed sheet for flooring material is further comprising a second composite material layer made of substantially same materials as those in the first composite material layer on a side of the backer layer and on the urethane type resin layer.

According to the present invention, the disposition of the second composite material layer results in its set between the backer layer and the urethane type resin layer in such a way that the adhesion between the backer layer, the second composite material layer and the urethane type resin layer is made satisfactory, and thus the stability of the flooring material can be improved. Because there are disposed the first composite material layer and the second composite material layer that are made of substantially same materials on the upper and lower sides of the printed sheet for flooring material, the cost for fabricating the first composite material layer and the second composite material layer is made lower as compared to the case where the second composite material layer is formed as a layer different in materials from the first composite material layer.

The above object of the present invention can be achieved by a flooring material comprising a backer layer, the printed sheet for flooring material mentioned above, and a top sheet laminated in this order.

According to the present invention, there can be provided a flooring material in which each of the layers is hardly delaminated and which thereby acquires stability and is also improved in the strength thereof because the flooring material is made with the above described printed sheet for flooring material.

According to the printed sheet for the flooring material of the above present invention, there can be provided a flooring material in which each of the layers is hardly delaminated and which thereby acquires stability and is also improved in the strength thereof because the flooring material is made with the above described printed sheet for flooring material.

According to the flooring material of the above present invention, there can be provided a flooring material in which each of the layers is hardly delaminated and which thereby acquires stability and is also improved in the strength thereof.

### BRIEF DESCRIPTION OF THE DRAWINGS

FIG. 1 is a sectional view illustrating an embodiment of a printed sheet for flooring material of the present invention;

FIG. 2 is a sectional view illustrating another embodiment of the printed sheet for flooring material of the present invention;

FIG. 3 is a sectional view illustrating yet another embodiment of the printed sheet for flooring material of the present invention; and

FIG. 4A and FIG. 4B are sectional views illustrating an embodiment of a flooring material fabricated by disposing the printed sheet for flooring material of the present invention.

Each meaning of the reference numbers in the drawings are as follows:

10A, 10B, 10C: printed sheet for flooring material, 11: urethane type resin layer, 12: printed layer, 13: first composite material layer, 131: EMAA resin layer, 132: first polyethylene resin layer, 133: second polyethylene resin layer, 14: second composite material layer, 141: EMAA resin layer, 142: third polyethylene resin layer, 143: fourth polyethylene resin layer, 20: backer layer, 30: top sheet and 40: flooring material.

### DESCRIPTION OF THE PREFERRED EMBODIMENTS

Hereinafter, a printed sheet for flooring material and a flooring material of the present invention are described with reference to the accompanying drawings.

(Printed Sheet for Flooring Material)

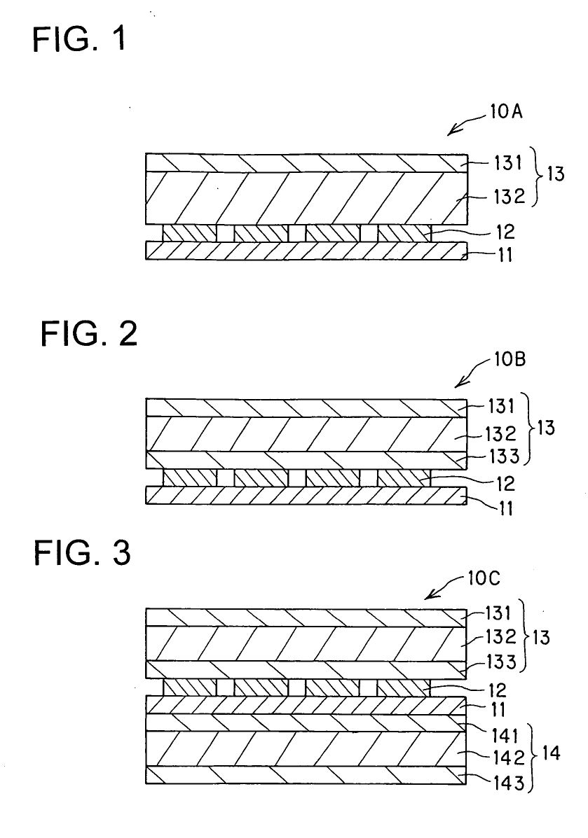

The printed sheet for flooring material of the present invention is described with reference to FIGS. 1 to 4.

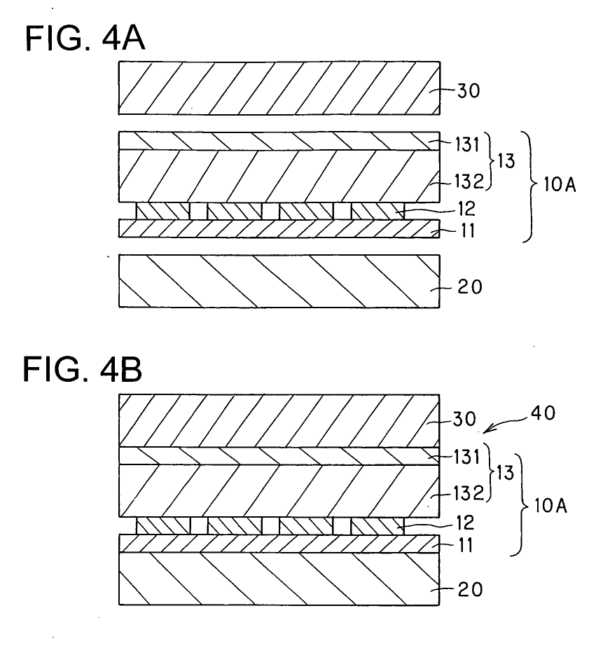

FIG. 1 is a sectional view illustrating an embodiment of the printed sheet for flooring material of the present invention; FIG. 2 is a sectional view illustrating another embodiment of the printed sheet for flooring material of the present invention; FIG. 3 is a sectional view illustrating yet another embodiment of the printed sheet for flooring material of the present invention; and FIG. 4A and FIG. 4B are sectional views illustrating an embodiment of a flooring material fabricated by disposing the printed sheet for flooring material of the present invention.

The printed sheet for flooring material 10A of the present invention is to be disposed between a backer layer 20 and a top sheet 30 in a flooring material 40 to be described below with reference to FIG. 4A and FIG. 4B. As shown in FIG. 1, in the printed sheet for flooring material 10A of the present invention, a urethane type resin layer 11 and a first composite material layer 13 are disposed as indispensable layers sequentially from a side of the backer layer 20 in the printed sheet for flooring material 10A. As also shown in FIG. 1, the first composite material layer 13 includes at least an EMAA resin layer 131 and a first polyethylene resin layer 132 as disposed sequentially from a side of the top sheet 30 of the first composite material layer 13. A printed layer 12 is a layer indispensable for the printed sheet for flooring material 10A, but is disposed at an optional position.

As shown in FIG. 2, in a printed sheet for flooring material 10B of the present invention, the first composite material layer 13 may further include a second polyethylene resin layer 133 on the urethane type resin layer 11-facing (the printed layer 12-facing) side of the first composite material layer 13. As also shown in FIG. 3, a printed sheet for flooring material 10C of the present invention may further include a second composite material layer 14, made of substantially same materials as those used in the first composite material layer 13, on a side of the backer layer 20 of the urethane type resin layer 11. In this invention, the composite material layer means having plural layers and the each layer consist of different material.

The construction of each layer in each of the printed sheets for flooring material 10A, 10B and 10C is described below.

The urethane type resin layer 11 is a layer to adhere the printed layer 12 or the first composite material layer 13 to the backer layer 20 or the second composite material layer 14. The material for the urethane type resin layer 11 is not particularly limited in properties as long as the material is a urethane type resin for which a polyisocyanate and an active hydrogen group containing compound (a polyol) are the main materials thereof. However, as the material for the urethane type resin layer 11, a two-pack curing type urethane type resin is preferably used. The two-pack curing type urethane type resin is a urethane type resin in which the polyol is the base resin and an isocyanate is a crosslinker (curing agent) The polyol is a compound having two or more hydroxy groups in one molecule thereof; examples of the polyol to be used include polyethylene glycol, polypropylene glycol, acrylpolyol, polyester polyol, polyether polyol, polycarbonate polyol, and polyurethane polyol. The isocyanate to be used is a polyisocyanate that has two or more isocyanate groups in one molecule thereof; examples of the polyisocyanate to be used include, for example, aromatic isocyanates such as 2,4-tolylenediisocyanate, xylenediisocyanate and 4,4′-diphenylmethanediisocyanate; and aliphatic (or alicyclic) isocyanates such as 1,6-hexamethylenediisocyanate, isophoronediisocyanate, hydrogenated tolylenediisocyanate and hydrogenated diphenylmethanediisocyanate. Additionally, adducts and polymers of the above various isocyanates, for example, adducts of tolylenediisocyanate, the trimer of tolylenediisocyanate and the like may be used.

Here, the layer thickness of the urethane type resin layer 11 is not particularly limited, but is usually about 2 to 20 μm.

The printed layer 12 is a layer printed on the urethane type resin layer 11. The material of the printed layer 12 is usually formed by using an ink such as a one-pack or two-pack curing type urethane ink based on acrylpolyol, polyester polyol or urethane polyol containing an isocyanate as curing agent. Here, the printed layer 12 particularly formed of a two-pack curing type urethane ink based on acrylpolyol is preferable because such a printed layer 12 is excellent in the adhesion to the urethane type resin layer 11. As the isocyanate, aromatic or aliphatic (inclusive of alicyclic) isocyanates may be used; particularly preferable are aliphatic (inclusive of alicyclic) isocyanates composed of 1,6-hexamethylenediisocyanate, hydrogenated tolylenediisocyanate, and polymers or adducts of these isocyanates.

This ink may contain the following ultraviolet absorbers and photostabilizers, in a content about 0.1 to 5% by weight. The ultraviolet absorbers are such as salicylate type, benzotriazole type and benzophenone type based ultraviolet absorbers, in particular, for example, phenylsalicylate (trade name: Salol), 2-hydroxyphenylbenzotriazole (trade name: Tinuvin), 2-hydroxybenzophenone, R₁R₂C═CCR₃ (R₃: an electronegative group) (trade names: Uvinul N-35, N-539), and dimethyl-p-methoxybenzylidinemalonate. And the photostabilizers are hindered amine photostabilizers such as hindered amine photostabilizers manufactured by Ciba-Geigy (trade names: Tinuvin 700, Tinuvin 744, Tinuvin 765, Tinuvin 622 and Tinuvin 144), a hindered amine stabilizer manufactured by Chimosa (trade name: Chimosasorb 944), hindered amine photostabilizers manufactured by Adeka Argus Chemical (trade names: Mark LA-57, Mark LA-62, Mark LA-67, Mark LA-63 and Mark LA-68); and a hindered amine photostabilizer manufactured by B.F. Goodrich (trade name: Goodrite UV-3034).

The layer thickness of the printed layer 12 is not particularly limited, but usually is about 1 to 10 μm.

In each of FIGS. 1 to 4, there is adopted an embodiment in which the printed layer 12 is disposed on the urethane type resin layer 11 in a partial manner; however, no particular constraint is imposed on the embodiment, and the printed layer 12 may be disposed over the whole surface of the urethane type resin layer 11. Also in each of FIGS. 1 to 4, for depictive purpose, there are depicted spaces between the printed layers 12, but in each of the usual printed sheets for flooring material 10A, 10B and 10C and the flooring material 40, the urethane type resin layer 11 and the first composite material layer 13 are adhered to each other. The printed layer 12 is disposed as an indispensable member in the printed sheet for flooring material 10A of the present invention, but the position of the printed layer 12 is not limited. Consequently, in each of FIGS, 1 to 4, the printed layer 12 is located on the urethane type resin layer 11, but reversely, the printed layer 12 may be disposed on the lower side of the urethane type resin layer 11 in each of the FIGS.

The first composite material layer 13 is usually formed in a sheet so as to have at least the EMAA resin layer 131 and the first polyethylene resin layer 132 in this order from a side of the top sheet 30 of the first composite material layer 13. The first composite material layer 13 may include a second polyethylene resin layer 133 on a side of the backer layer 20 of the first composite material layer 13.

As a material for the EMAA resin layer 131, an EMAA resin, namely, an ethylene-methacrylic acid copolymer is mainly used. The EMAA resin is not particularly limited in properties as long as it is an ethylene-methacrylic acid copolymer resin; however, the copolymerization proportions of ethylene and methacrylic acid in the EMAA resin are preferably controlled in such a way that the fraction of MA (the fraction of methacrylic acid) is about 1 to 20% by mass, preferably about 3 to 7% by mass, and the balance is the fraction of ethylene. When the fraction of MA exceeds 20% by mass, the EMAA resin becomes too hard to be suitable for the EMAA resin layer 131; when the fraction of MA is less than 1% by mass, the EMAA resin becomes soft and sometimes becomes insufficient in physical properties as flooring material. For the EMAA resin, for example, “Nucrel” (trade name) manufactured by Mitsui-Du Pont Polychemical Co., Ltd. or the like is used. In the EMAA resin layer 131, if needed, the EMAA resin may be mixed with other materials: highly crystalline nonelastomer polyolefin resins such as polyethylene (LLDPE (linear low density polyethylene), LDPE (low density polyethylene), MDPE (medium density polyethylene), or HDPE (high density polyethylene)), polypropylene (isotactic type, syndiotactic type or a mixture thereof), polymethylpentene, polybutene, ethylene-propylene copolymer and propylene-butene copolymer; or various olefin thermoplastic elastomers. These mixing materials are selected on the basis of the adhesion to an adjacent layer and other required physical properties.

As a material for the first polyethylene resin layer 132, polyethylene resin is mainly used. The polyethylene resin is not particularly limited, but LLDPE (linear low density polyethylene) resin, LDPE resin, MDPE resin or HDPE resin is preferably used. The LLDPE resin is not particularly limited in properties, and those resins which are generally called LLDPE resin are used.

As a material for the second polyethylene resin layer 133, polyethylene resin is mainly used. The polyethylene resin is not particularly limited, but LLDPE resin, HDPE resin, LDPE resin, MDPE resin and the like are preferably used. The LLDPE resin is not particularly limited in properties, and those resins which are generally called LLDPE resin are used. The HDPE resin is also not particularly limited in properties, and those resins which are generally called HDPE resin are used. The use of HDPE resin for the second polyethylene layer 133 provides the laminate of the first composite material layer 13 with firm (sustainability and toughness), to lead to development of sufficient adaptability as a printing substrate. In the second polyethylene resin layer 133, if needed, the polyethylene resin may be mixed with other materials such as EMMA resin.

Now, the layer thickness of the first composite material layer 13 is described below.

The layer thickness of the first composite material layer 13 is not particularly limited, but is usually about 60 to 80 Mm. The layer thickness of the EMAA resin layer 131 is also not particularly limited, but is usually about 15 to 20 μm. The layer thickness of the first-polyethylene resin layer 132 is also not particularly limited, but is usually about 30 to 50 μm. The layer thickness of the second polyethylene resin layer 133 is also not particularly limited, but is usually about 5 to 10 μm. When the EMAA resin layer 131, the first polyethylene resin layer 132 and the second polyethylene resin layer 133 each are made to be as thinnest as possible, the layer thickness of the first composite material layer 13 becomes 50 μm; such a small layer thickness of the first composite material layer 13 degrades the adaptability to printing, and accordingly, it is preferable that one or two of these layers each are made to have the lower-limit layer thickness and the other layers each are made to have a layer thickness other than the lower limit thickness, and consequently the layer thickness of the first composite material layer 13 is made to be 60 μm or more.

When the first composite material layer 13 is composed only of the EMAA resin layer 131 and the first polyethylene resin layer 132, the layer thickness ratio between the EMAA resin layer 131 and the first polyethylene resin layer 132 is not particularly limited, but usually the ratio of EMAA resin layer 131 to first polyethylene resin layer 132 is about 5:8 to 5:16.

When the first composite material layer 13 is composed of the EMAA resin layer 131, the first polyethylene resin layer 132 and the second polyethylene resin layer 133, the layer thickness ratios between the EMAA resin layer 131, the first polyethylene resin layer 132 and the second polyethylene resin layer 133 are not particularly limited, but usually the ratio of EMAA resin layer 131 to first polyethylene resin layer 132 is about 5:8 to 2:5, the ratio of EMAA resin layer 131:second polyethylene resin layer 133 is about 2:1 to 1:1, and the ratio of first polyethylene resin layer 132 to second polyethylene resin layer 133 is about 5:1 to 1:1.

When the first composite material layer 13 is composed of the EMAA resin layer 131, the first polyethylene resin layer 132 and the second polyethylene resin layer 133, curling of the first composite material layer 13 and the printed sheets for flooring material 10A, 10B and 10C can be prevented by equalizing the layer thickness of the EMAA resin layer 131 and the layer thickness of the second polyethylene resin layer 133 and by symmetrizing the first composite material layer 13 along the layer thickness direction.

On a side of the backer layer 20 of each of the printed sheets for flooring material 10A, 10B and 10C, a layer made of appropriate materials may be disposed in consideration of adhesion.

When another layer is disposed on a side of the backer layer 20 of each of the printed sheets for flooring material 10A, 10B and 10C, it is preferable to use a second composite material layer 14 composed of substantially same materials as in the first composite material layer 13. In this case, the first composite material layer 13 and the second composite material layer 14 can be collectively fabricated into one sheet to be applied to the first composite material layer 13 and the second composite material layer 14 in each of the printed sheets for flooring material 10A, 10B and 10C. Thus, it leads to an advantage that the cost for the printed sheet for flooring material can be reduced.

Specifically, the second composite material layer 14 includes at least an EMAA resin layer 141 and a third polyethylene resin layer 142. And a fourth polyethylene resin layer 143 is optionally disposed on the side of the third polyethylene layer 142 of the second composite material layer 14. The EMAA resin layer 141 is made of substantially same materials as in the EMAA resin layer 131, the third polyethylene resin layer 142 is made of substantially same materials as in the first polyethylene resin layer 132, and the fourth polyethylene resin layer 143 is made of substantially same materials as in the second polyethylene resin layer 133.

The printed sheets for flooring material 10A, 10B and 10C of the present invention each may be a combination of the urethane type resin layer 11, the printed layer 12, the first composite material layer 13 and the second composite material layer 14 if needed, each layer being made of the above described materials. The printed sheets for flooring material 10A, 10B and 10C of the present invention each may be provided with another layer if needed.

The printed sheets for flooring material 10A, 10B and 10C of the present invention each are not particularly limited in the fabrication method thereof as long as these sheets have the above described layer configurations; however, these sheets are usually fabricated as follows.

First, the first composite material layer 13 is formed. The method for forming the first composite material layer 13 is not particularly limited, but usually it is formed in a sheet by co-extrusion of two or three layers or the like. The first composite material layer 13 may also be formed by forming one layer by extrusion and by extrusion-laminating the other layers on this layer. Each of the layers 131, 132 and 133 may be formed by laminating two layers made of same material.

Next, the printed layer 12 is formed on the sheet of the first composite material layer 13. The forming method of the printed layer 12 is not particularly limited; it is formed by various hitherto well known printing methods such as letter press printing including gravure printing, type printing and flexographic printing; planographic printing including planographic offset printing and di-litho printing; stencil printing including silk screen printing; electrostatic printing; and ink-jet printing.

Further, the urethane type resin layer 11 is formed, from above the printed layer 12, on the first composite material layer 13. The formation method of the urethane type resin layer 11 is not particularly limited; for example, the urethane type resin layer 11 is laminated on the printed layer 12 by various hitherto well known formation methods such as roll coating, curtain flow coating, wire bar coating, reverse roll coating, gravure coating, gravure reverse coating and microgravure coating. The printing method of the urethane type resin layer 11 is also not particularly limited; however, the urethane type resin layer 11 is printed on the printed layer 12 by hitherto well known printing methods such as letter press printing including gravure printing, type printing and flexographic printing; planographic printing including planographic offset printing and di-litho printing; stencil printing including silk screen printing; electrostatic printing; and ink-jet printing.

As described above, the printed sheets for flooring material 10A and 10B are fabricated.

When the second composite material layer 14 is used, the second composite material layer 14 is formed in sheet in same manner as for the first composite material layer 13. Then, a sheet formed by laminating the first composite material layer 13, the printed layer 12 and the urethane type resin layer 11 is laminated with the sheet of the second composite material layer 14, and then the individual layers are adhered to each other by dry lamination to fabricate the printed sheet for flooring material 10C. As the dry lamination adhesive to be used for dry lamination, a urethane type adhesive that is the two-pack curing type adhesive in which a polyisocyanate, a polyol and a catalyst are mixed immediately before the use, and an epoxy adhesive are preferably used. The two-pack curing type urethane adhesive is a urethane type adhesive in which a polyol is the main component and an isocyanate is a crosslinker (curing agent). The polyol and the isocyanate are same as those cited as examples for the above described two-pack curing type urethane type resin. The dry lamination adhesive is not shown in the figure, but is coated for lamination between the urethane type resin layer 11 and the EMAA resin layer 141 in FIG. 3, and between the urethane type resin layer 11 and the backer layer 20 in FIG. 4A. The second composite material layer 14 may be laminated on the urethane type resin layer libyheat lamination, extrusion lamination (melt extrusion coating, EC), or co-extrusion coating (melt co-extrusion coating, CO-EC); the backer layer 20 as a single layer may be laminated on the urethane type resin layer 11 by heat lamination or extrusion coating; however, preferable is the above described adhesion by dry lamination, which attains a stable adhesion strength.

(Flooring Material)

The flooring material of the present invention is described with reference to FIG. 4A and FIG. 4B.

FIG. 4A is a sectional view schematically illustrating the preliminary step for fabricating the flooring material with the backer layer, the printed sheet for flooring material and the top sheet; and FIG. 4B is a sectional view schematically illustrating the fabricated flooring material.

As shown in FIG. 4A, the backer layer 20, the printed sheet for flooring material 10A and the top sheet 30 are sequentially laminated. Then, usually by heat lamination, the adhesion between the backer layer 20 and the printed sheet for flooring material 10A, and the adhesion between the printed sheet for flooring material 10A and the top sheet 30 are carried out, to fabricate the flooring material 40 as shown in FIG. 4B.

Now, the backer layer 20 and the top sheet 30 are described below.

A material for the backer layer 20 is not particularly limited as long as the material can support the printed sheet for flooring material 10A and the top sheet 30 of the flooring material 40, and is satisfactory in adhesion to the printed sheet for flooring material 10A. As a material for the backer layer 20, the following materials can be used as a single compound or as a mixture with acrylic resin or polyethylene. Examples thereof include an ionomer resin (trade name: Himilan; Mitsui-Du Pont Polychemical Co., Ltd.), an EAA resin (ethylene-acrylic acid copolymer) (trade name: Primacor; Dow Chemical Japan Co., Ltd.), an EMMA resin (ethylene-methyl methacrylate copolymer resin) (trade name: Acryft; Sumitomo Chemical Industry Co., Ltd.), an EMAA resin (ethylene-methacrylic acid random copolymer) (trade name: Nucrel; Mitsui-Du Pont Polychemical Co., Ltd.), EMA (ethylene-methyl acrylate copolymer) (trade name: EMAC; Nagase Sangyo Co., Ltd.), EEA (ethylene-ethyl acrylate copolymer) (trade name: NUCEEA copolymer; Japan Unicar Co., Ltd.; trade name: Evaflex-EEA; Mitsui-Du Pont Polychemical Co., Ltd.). As the backer layer 20, there can also be used a layer formed by laminating two or more sheets each made of same resin or the different resins selected from the above described resins if needed.

The layer thickness of the backer layer 20 is not particularly limited, but is usually about 100 to 1000 μm, and preferably about 500 to 800 μm. The formation method of the backer layer 20 is also not particularly limited, but usually the backer layer 20 is formed in sheet by extrusion, co-extrusion or the like.

A material for the top sheet 30 is not particularly limited as long as the material can protect the backer layer 20 and the printed sheet for flooring material 10A. However, for the top sheet 30, for example, olefin resins or polyester resins can be used, and olefin resins such as polyethylene, polypropylene, polybutene and ionomers are preferably used. From the viewpoint of abrasion resistance, ionomers are particularly preferably used.

The layer thickness of the top sheet 30 is not particularly limited, but is usually about 100 to 800 μm, and preferably about 500 to 700 μm. The formation method of the top sheet 30 is also not particularly limited, but usually the top sheet 30 is formed in sheet by extrusion or the like.

The flooring material 40 of the present invention may be a combination of the backer layer 20, the printed sheets for flooring material 10A, 10B and 10C, and the top sheet 30, each layer being made of the above described materials. The flooring material 40 of the present invention may be provided with other layers if needed.

The fabrication method of the flooring material 40 of the present invention is usually such that, as described above, the backer layer 20, the printed sheet for flooring material 10A and the top sheet 30 are laminated, and the individual layers are adhered to each other by dry lamination to fabricate the flooring material 40.

### EXAMPLES

Hereinafter, the present invention is described with reference to examples and a comparative example.

### Example 1

As the first composite material layer, an 80 μm thick sheet was fabricated by co-extrusion molding of a 20 μm thick EMAA resin layer made of the EMAA resin having the fraction of MA of 5% and a 60 μm thick first polyethylene resin layer made of LLDPE(1). In this case, the first polyethylene resin layer was formed by co-extruding a 50 μm thick layer contacting with the EMAA resin and another 10 μm thick layer non-contacting with the EMAA resin.

The surface on the first polyethylene layer side of the first composite material layer was subjected to corona treatment, and on the thus treated surface, a printed layer was partially formed by gravure printing using a two-pack curing type urethane ink composed of acrylpolyol and 1,6-hexamethylene diisocyanate.

Then, on the first composite material layer and the printed layer, a urethane type resin layer was formed as a 15 μm thick layer by laminating a urethane type resin by gravure reversing process. Thus, a printed sheet for flooring material was fabricated.

As the materials constituting the backer layer, there were prepared an 800 μm thick first backer material composed of a multilayer extrusion sheet including PE and EMA, and an 800 μm thick second backer material composed of a multilayer extrusion sheet including EMA and an acrylic resin. As the material for the top sheet, there was prepared a 600 μm thick sheet made of an ionomer resin.

The first backer material was superposed on the second backer material, the urethane type resin layer of the printed sheet for flooring material was further superposed on the first backer material, and the top sheet was further superposed on the printed sheet for flooring material; under this condition, heat lamination was carried out at a lamination temperature of 130° C and a lamination pressure of 23 kg/cm² to fabricate a flooring material laminated into a piece.

A same sheet as the sheet to be the first composite material layer was fabricated as a second composite material layer, and a same printed sheet for flooring material as the above described printed sheet for flooring material was fabricated. The thus fabricated printed sheet for flooring material and the thus fabricated sheet as the second composite material layer were superposed on each other in such a way that the urethane type resin layer of the printed sheet for flooring material and the EMMA resin layer in a form of sheet as the second composite material layer were in contact with each other. The thus laminated sheet was made to pass between lamination rolls heated to 40 to 70° C. to fabricate another printed sheet for flooring material. A flooring material of Example 1 was obtained, by fabricating a flooring material using a backer layer and a top sheet, in same manner as in the above described flooring material, except that the thus fabricated printed sheet for flooring material was used.

### Example 2

A flooring material of Example 2 was obtained by fabricating a printed sheet for flooring material and a flooring material in same manner as in Example 1, except that the layer thickness of the EMMA resin layer was 19 μm, and the first polyethylene resin layer was formed as a 30.5 μm thick single layer made of another LLDPE(2) and a 30.5 μm thick layer made of HDPE was formed as a second polyethylene resin layer on a side of the printed layer of the first polyethylene resin layer.

### Example 3

A flooring material of Example 3 was obtained by fabricating a printed sheet for flooring material and a flooring material in same manner as in Example 2, except that the layer thickness of the EMMA resin layer was 20 μm, and the first polyethylene resin layer was formed as a 40 μm thick single layer made of the above described LLDPE(2) and a second polyethylene resin layer was formed as a 20 μm thick layer made of a resin prepared by blending EMMA and the LLDPE (2) in a ratio of 3:7.

### Comparative Example 1

A flooring material of Comparative Example 1 was obtained by fabricating a printed sheet for flooring material and a flooring material in same manner as in Example 1, except that: a layer (upper) made of an ionomer resin in which the molecules of ethylene-methacrylic acid copolymer were crosslinked by metal ions was used in place of the first composite material layer in the flooring material of Example 1; and a layer (lower) obtained by laminating a 20 μm thick layer made of a resin obtained by blending EMAA and the above mentioned LLDPE (2), a 40 μm thick layer made of the LLDPE (2) and a 20 μm thick layer made of a resin obtained by blending EMAA and the LLDPE (2) was used in place of the second composite material layer of Example 1.

Here, it should be noted that the constructions of the first composite material layers (same constructions are applied for the second composite material layers) in Examples 1 to 3, and the constructions of the upper and lower layers in Comparative Example 1 are shown in Table 1.

TABLE 1

| | | | | | Layer |
|---|---|---|---|---|---|
| | | | | | thickness |
| | | | | | ratio |
| | | | | | (EMAA |
| | | | | | resin |
| | Total | | Material | Material | layer/first |
| | layer | Materials | in first | in second | PE resin |
| | thick- | in EMAA | polyethylene | polyethylene | layer/second |
| | ness | resin | resin | resin | PE resin |
| | [μm] | layer | layer | layer | layer) |
| Example 1 | 80 | EMAA- | LLDPE(1) | None | 1/3 |
| | | 5% MA | | | |
| | | fraction | | | |
| Example 2 | 80 | EMAA- | LLDPE(1) | HDPE | 5/8/8 |
| | | 5% MA | | | |
| | | fraction | | | |
| Example 3 | 80 | EMAA- | LLDPE(2) | EMMA + | 1/2/1 |
| | | 5% MA | | LLDPE(2) | |
| | | fraction | | | |
| Comp. | 80 | Ionomer resin based on | | | |
| Ex. 1 | | ethylene-methacrylic acid | | | |
| (upper) | | copolymer with intermolecular | | | |
| | | crosslinkage by metal ions | | | |
| Comp. | 80 | EMAA + | LLDPE(2) | EMAA + | 1/2/1 |
| Ex. 1 | | LLDPE(2) | | LLDPE(2) | |
| (lower) | | | | | |

(Evaluation Results)

The flooring materials of Examples 1 to 3 and Comparative Example 1 were subjected to an early delamination test and a delamination test subsequent to a weatherability test. The evaluation results thus obtained are shown in Table 2.

The early delamination test was carried out as follows: a flooring material was fabricated, and then the backer layer side and the top sheet side of the flooring material were pulled by means of a hitherto well known apparatus to measure the strength at delamination and the delamination interfaces were identified.

A weatherability test was carried out by means of a metal halide lamp-type ultra-accelerated weatherability tester (trade name: Metal Weather; manufactured by Daipla Wintes Co., Ltd.) as a 100-hour weatherability test. Subsequently, the above described delamination test was carried out.

Actually, 5 specimens were tested for each of Examples and Comparative Example in such a manner that all the specimens were subjected to the early delamination test and the delamination test after weatherability test. The values for each of Examples shown in Table 2 are the average values over the specimens concerned. The strength as a flooring material may be evaluated as satisfactory when a strength of 2.0 N/mm or more is attained in the early delamination test and a strength of 1.1 N/mm or more is attained in the delamination test after weatherability test.

TABLE 2

| | | | Delamination test after | |
|---|---|---|---|---|
| | Early delamination test | | weatherability test | |
| | Strength | Delamination | Strength | Delamination |
| | [N/mm] | interface | [N/mm] | interface |
| Example 1 | 3.98 | Within first | 2.33 | Within first |
| | | composite | | composite |
| | | material layer | | material layer |
| Example 2 | 2.29 | Within first | 1.88 | Within first |
| | | composite | | composite |
| | | material layer | | material layer |
| Example 3 | 2.95 | Within first | 2.3 | Between top |
| | | composite | | sheet and first |
| | | material layer | | composite |
| | | | | material layer |
| Comp. | 1˜3 | Between backer | 1˜5 | Between top |
| Ex. 1 | | layer and second | | sheet and first |
| | | composite | | composite |
| | | material layer | | material layer |

As can be seen from Table 2, in each of Examples, the layer delamination in the flooring material required a force as large as 2.2 N/mm or more, and the delamination interface was found within the first composite material layer; consequently, the flooring material of each of Examples hardly underwent delamination between the top sheet and the printed sheet for flooring material and between the printed sheet for flooring material and the backer layer, to be a flooring material improved in stability and strength. Additionally, even after weatherability test, each of Examples underwent no large changes in the strength and delamination interface from early delamination test. Furthermore, the strengths of each of Examples exhibited small variations about the values shown in Table 2 to lead to a high stability, but the strengths of Comparative Example 1 were large in variation as shown in Table 2.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No 2005-99840 filed on Mar. 30th, 2005, including specification, claims, drawings and summary are incorporated herein by reference in its entirety.

What is claimed is:

1. A printed sheet for flooring material to be disposed between a backer layer and a top sheet in a flooring material, wherein:
the printed sheet for flooring material comprises at least a urethane type resin layer, a printed layer, and a first composite material layer;
the printed sheet for flooring material comprises the urethane type resin layer and the first composite material layer in this order from a side of the backer layer in the printed sheet; and
the first composite material layer comprises at least an EMAA resin layer and a first polyethylene resin layer in this order from a side of the top sheet in the printed sheet.

2. The printed sheet for flooring material according to claim 1,
wherein the first composite material layer further comprises a second polyethylene resin layer made of a material different from a material for the first polyethylene resin layer on a side of the urethane type resin layer in the first composite material layer.

3. The printed sheet for flooring material according to claim 1,
further comprising a second composite material layer made of substantially same materials as those in the first composite material layer on a side of the backer layer and on the urethane type resin layer.

4. The printed sheet for flooring material according to claim 2,
further comprising a second composite material layer made of substantially same materials as those in the first composite material layer on a side of the backer layer and on the urethane type resin layer.

5. A flooring material comprising a backer layer, a printed sheet for flooring material, and a top sheet laminated in this order, wherein:
the printed sheet for flooring material comprises at least a urethane type resin layer, a printed layer, and a first composite material layer;
the printed sheet for flooring material comprises the urethane type resin layer and the first composite material layer in this order from a side of the backer layer in the printed sheet; and
the first composite material layer comprises at least an EMAA resin layer and a first polyethylene resin layer in this order from a side of the top sheet in the printed sheet.

6. The flooring material according to claim 5,
wherein the first composite material layer further comprises a second polyethylene resin layer made of a material different from a material for the first polyethylene resin layer on a side of the urethane type resin layer in the first composite material layer.

7. The flooring material according to claim 5,
further comprising a second composite material layer made of substantially same materials as those in the first composite material layer on a side of the backer layer and on the urethane type resin layer.

8. The flooring material according to claim 6,
further comprising a second composite material layer made of substantially same materials as those in the first composite material layer on a side of the backer layer and on the urethane type resin layer.
